(19) United States
(12) Patent Application Publication
(10) Pub. No.: US 2016/0139646 A1
(43) Pub. Date: May 19, 2016

(54) INFORMATION PROCESSING APPARATUS AND INFORMATION PROCESSING SYSTEM

(71) Applicant: Satoru SHIGA, Tokyo (JP)

(72) Inventor: Satoru SHIGA, Tokyo (JP)

(73) Assignee: RICOH COMPANY, LTD., Tokyo (JP)

(21) Appl. No.: 14/940,207

(22) Filed: Nov. 13, 2015

(30) Foreign Application Priority Data
Nov. 18, 2014 (JP) 2014-233474
Apr. 1, 2015 (JP) 2015-074986
Jun. 11, 2015 (JP) 2015-117982

(51) Int. Cl. G06F 1/32

(52) U.S. Cl. CPC G06F 1/329; G06F 1/3209

(57) ABSTRACT

An information processing apparatus includes a request unit configured to request information processing to an image processing apparatus via a network; a return unit configured to cause a request processing apparatus to return to a first operation mode from a second operation mode, wherein the request processing apparatus supplements a function when the image processing apparatus executes the information processing, and the request processing apparatus operates in the first operation mode and in the second operation mode in which power consumption is lower than that of the first operation mode; and a determining unit configured to determine whether the requested information processing is a predetermined type. When it is determined that the information processing is the predetermined type, the request processing apparatus is caused to return to the first operation mode from the second operation mode, before the information processing is requested to the request processing apparatus.

### BACKGROUND OF THE INVENTION

1. Field of the Invention

The present invention relates to an information processing apparatus and an information processing system.

2. Description of the Related Art

Devices including a plurality of functions are known, such as an MFP (Multi-Function Peripheral). Furthermore, there is known an information processing system in which some of the functions that can be provided by an MFP are distributed across other devices in a network. In the information processing system, there is no need for the MFP to provide all functions by a single device, and therefore the load of the MFP can be reduced. Furthermore, even an inexpensive MFP of a low-end class can provide the same functions as those of an expensive MFP of a high-end class to the user, by receiving functions provided from devices distributed in the network.

Therefore, when a user installs an MFP together with an information processing system, the installation cost of the MFP can be reduced. Furthermore, as the functions of devices arranged in the network are improved, the functions of all MFPs receiving functions provided from the information processing system can be improved (for example, the upgrading of a function). The information processing system has many advantages as above.

Incidentally, the MFPs and devices in the information processing system often include an operation mode referred to as an energy saving mode, in which the power consumption can be reduced. When the user uses the functions of the MFP and devices in a state where the MFP and devices are in an energy saving mode, not only the MFP, but also the devices need to return from the energy saving mode. Accordingly, there is a devised technology for causing a plurality of MFPs and devices in a network to return from the energy saving mode (see, for example, Patent Document 1). Patent Document 1 discloses a device cooperation system in which a plurality of cooperation devices in a network complete the process of returning from the energy saving mode at about the same time.

However, in the device cooperation system disclosed in Patent Document 1, a case where the time required for returning from the energy saving mode may differ according to the function, is not considered. For example, when there is a function for which the time required for returning from the energy saving mode is T1, and a function for which the time required for returning from the energy saving mode is T2 (>T1), the waiting time becomes long for the user who wants to user the latter function.

Patent Document 1: Japanese Laid-Open Patent Publication No. 2011-233106

### SUMMARY OF THE INVENTION

The present invention provides an information processing apparatus and an information processing system, in which one or more of the above-described disadvantages are eliminated.

According to an aspect of the present invention, there is provided an information processing apparatus for requesting information processing via a network, the information processing apparatus including a request unit configured to send a request for the information processing to at least one image processing apparatus via the network; a return unit configured to cause a request processing apparatus to return to a first operation mode from a second operation mode, wherein the request processing apparatus supplements a function when the image processing apparatus executes the information processing, and the request processing apparatus operates in the first operation mode and in the second operation mode in which power consumption is lower than that of the first operation mode; and a determining unit configured to determine whether the information processing requested by the request unit is a predetermined type, wherein when the determining unit determines that the information processing is the predetermined type, the return unit causes the request processing apparatus to return to the first operation mode from the second operation mode, before the request unit sends the request for the information processing to the request processing apparatus.

According to an aspect of the present invention, there is provided an information processing system including an image processing apparatus; a request processing apparatus configured to operate in a first operation mode and in a second operation mode in which power consumption is lower than that of the first operation mode, wherein the request processing apparatus supplements a function when the image processing apparatus executes information processing; and an information processing apparatus configured to send a request for the information processing to the image processing apparatus via a network, wherein the information processing apparatus includes a return unit configured to cause the request processing apparatus to return to the first operation mode from the second operation mode, and a determining unit configured to determine whether the information processing requested to the image processing apparatus is a predetermined type, wherein when the determining unit determines that the information processing is the predetermined type, the return unit causes the request processing apparatus to return to the first operation mode from the second operation mode, before sending the request for the information processing to the request processing apparatus.

According to an aspect of the present invention, there is provided a non-transitory computer-readable recording medium storing a program that causes a computer to execute a process, the computer constituting an information processing apparatus for requesting information processing via a network, the process including sending a request for the information processing to at least one image processing apparatus via the network; causing a request processing apparatus to return to a first operation mode from a second operation mode, wherein the request processing apparatus operates in the first operation mode and in the second operation mode in which power consumption is lower than that of the first operation mode; and determining whether the requested information processing is a predetermined type, wherein when it is determined that the information processing is the predetermined type, the request processing apparatus is caused to return to the first operation mode from the second operation mode, before the request for the information processing is sent to the request processing apparatus.

### BRIEF DESCRIPTION OF THE DRAWINGS

Other objects, features and advantages of the present invention will become more apparent from the following detailed description when read in conjunction with the accompanying drawings, in which:

FIG. 1 illustrates an example of a configuration of an information processing system according to an embodiment;

FIG. 2 is a hardware block diagram of an image processing apparatus, an information processing apparatus, and a user PC constituting the information processing system according to an embodiment;

FIG. 3 is an example of a functional block diagram of the devices constituting the information processing system according to an embodiment;

FIG. 4 illustrates an example of a graphical user interface (GUI) displayed on the user PC;

FIG. 5 illustrates an example of a sub GUI by which various settings can be made according to an embodiment;

FIG. 6 illustrates an example of input screen information displayed when the user clicks a button for “cooperation function setting” in FIG. 5;

FIGS. 7A through 7C illustrate examples of an energy saving return instruction packet according to an embodiment sent from the user PC, an address management table, and a device management table;

FIG. 8 is a flowchart of a process according to a first embodiment executed by the information processing system;

FIG. 9 is a flowchart of a first modification example of the process according to the first embodiment;

FIG. 10 is a flowchart of a second modification example of the process according to the first embodiment;

FIG. 11 is a flowchart of a process according to a second embodiment executed by the information processing system;

FIG. 12 is a flowchart of a first modification example of the process according to the second embodiment; and

FIG. 13 is a flowchart of a second modification example of the process according to the second embodiment.

### DETAILED DESCRIPTION OF THE PREFERRED EMBODIMENTS

In the following, a description is given of embodiments of the present invention; however, the present invention is not limited to the following embodiments.

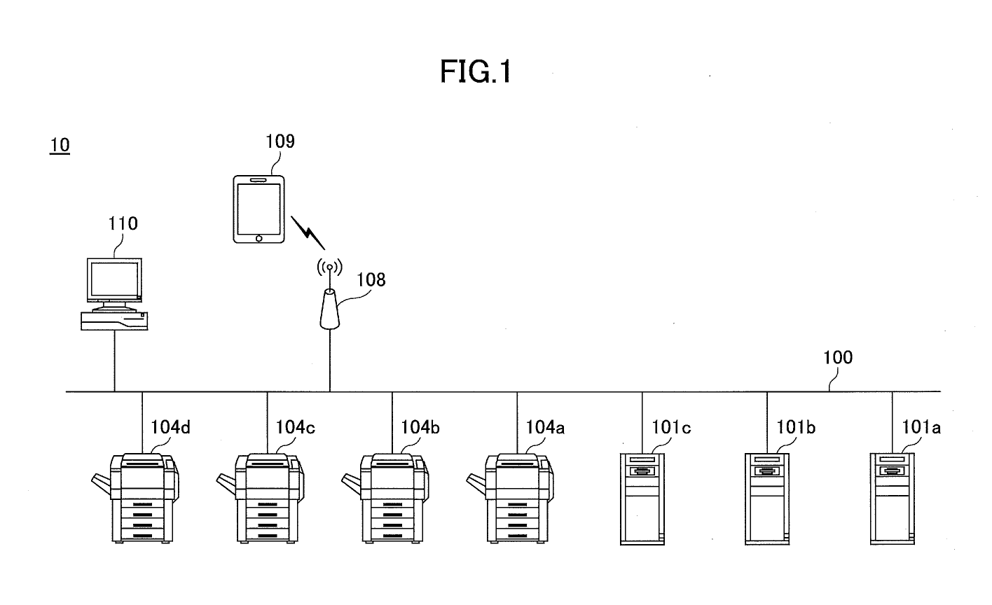

FIG. 1 illustrates an example of a configuration of an information processing system 10 according to the present embodiment. The information processing system 10 includes a plurality of devices that are connected via a network 100. The network 100 is constructed by at least one of a LAN in a facility such as a company in which a plurality of devices are arranged, a provider network of a provider connecting the LAN to the Internet, a line provided by a line enterprise, etc. Furthermore, the network 100 may include a WAN and the Internet including a plurality of LANs. The network 100 may be constructed by wired or wireless connections, or by a combination of wired and wireless connections.

In FIG. 1, for example, a user PC (Personal Computer) 110, a mobile terminal 109, and image processing apparatuses 104a, 104b, 104c, and 104d are connected to the network 100. The user PC 110 is a device for being used by a user and for issuing a service request. The mobile terminal 109 is, for example, a tablet terminal, a smart device such as a smartphone, or a notebook PC, which is connected to the network 100 via a wireless LAN access point 108. The mobile terminal 109 is used in a similar manner as the user PC 110. In the following, at least one of the mobile terminal 109 and the user PC 110 is simply referred to as the user PC 110, when it is not particularly necessary to distinguish these two devices.

Furthermore, the image processing apparatuses 104a, 104b, 104c, and 104d are, for example, MFPs (Multi-Function Peripherals), which acquire requests for services from the user. Note that the MFP may also be referred to as a multifunction copier or an image forming apparatus. The image processing apparatuses 104a, 104b, 104c, and 104d respectively include functions that can be provided to the user, and different functions are provided to the user, according to different models, grades, and option configurations of the image processing apparatuses 104a, 104b, 104c, and 104d. The image processing apparatuses 104a, 104b, 104c, and 104d provide a function in response to a service request from the user PC 110. Furthermore, each of the image processing apparatuses 104a, 104b, 104c, and 104d can be operated by the user, and when the image processing apparatuses 104a, 104b, 104c, and 104d directly receive a service request by a user's operation, the image processing apparatuses 104a, 104b, 104c, and 104d provide a service in response to the request.

When an MFP is a specific example of the image processing apparatuses 104a, 104b, 104c, and 104d according to the present embodiment, a scanner function, a print function, a fax function, and a network access function are included. The image processing apparatuses 104a, 104b, 104c, and 104d provide a service in response to a service request from the user, by itself or by a function of cooperating with an external device.

Furthermore, when the processing ability of the own device is insufficient for processing a service requested by the user, the image processing apparatuses 104a, 104b, 104c, and 104d request information processing apparatuses 101a, 101b, and 101c, which are connected via the network 100, to perform the processing. The image processing apparatuses 104a, 104b, 104c, and 104d receive the necessary functions from the information processing apparatuses 101a, 101b, and 101c in response to the request, and the image processing apparatuses 104a, 104b, 104c, and 104d provide the service corresponding to the user request, to the user.

Note that in the following, the image processing apparatuses 104a, 104b, 104c, and 104d are simply referred to as an “image processing apparatus 104”, when these apparatuses do not particularly need to be distinguished from each other.

The information processing apparatuses 101a, 101b, and 101c may be implemented as a PC, a workstation, a server computer, etc., which are remotely connected to the user PC 110 via the network 100. Furthermore, in another embodiment, the information processing apparatuses 101a, 101b, and 101c may be an MFP that can provide a server function.

The information processing apparatuses 101a, 101b, and 101c according to the present embodiment provide the image processing apparatus 104 with some of the functions that are supposed to be provided by the image processing apparatus 104, without having the user notice this. Therefore, the user can make a service request to any image processing apparatus 104a, 104b, 104c, and 104d without considering the model, and the user can receive the functions provided by the image processing apparatus 104 to which the service request has been made.

Note that the information processing apparatuses 101a, 101b, and 101c function as a request processing apparatus according to the present embodiment. In the following, the information processing apparatuses 101a, 101b, and 101c are simply referred to as an “information processing apparatus 101”, when these apparatuses do not particularly need to be distinguished from each other.

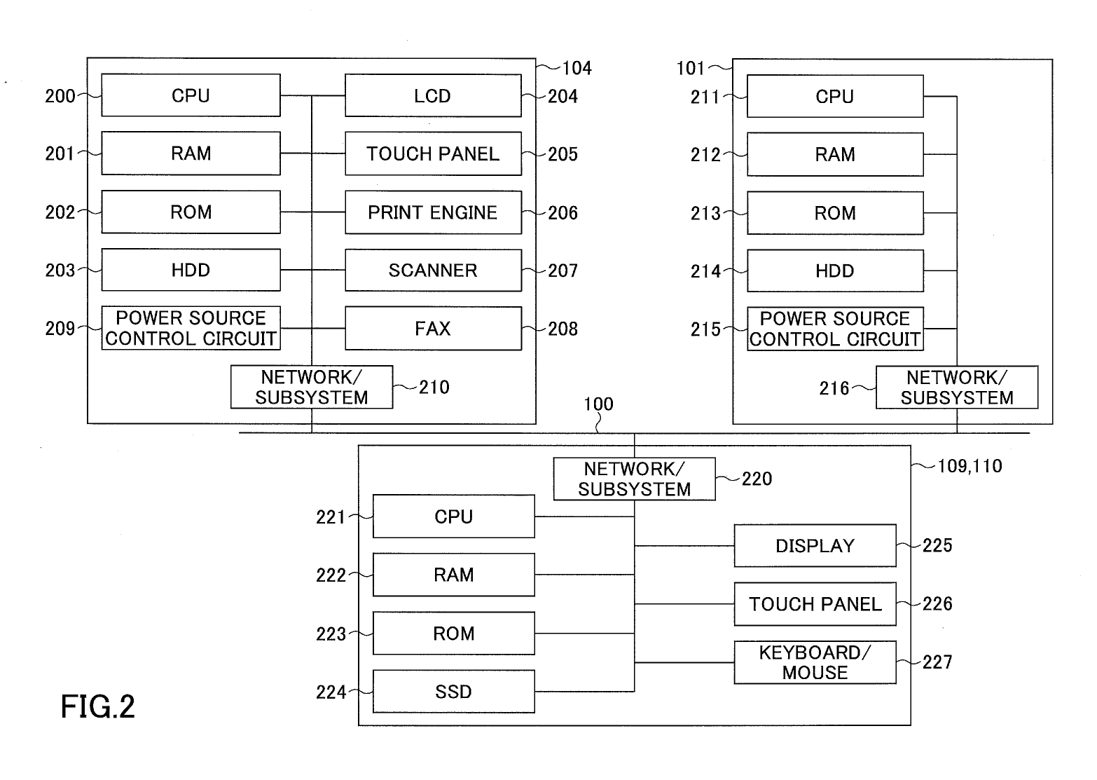

FIG. 2 is a hardware block diagram of the image processing apparatus 104, the information processing apparatus 101, and the user PC 110 and the mobile terminal 109 constituting the information processing system 10 according to the present embodiment. The image processing apparatus 104 includes a CPU 200, a RAM 201, a ROM 202, and a HDD (Hard Disk Drive) 203. The CPU 200 loads the programs stored in the HDD 203 into the RAM 201, and provides various control processes. The CPU 200 is a central processing unit for managing and controlling the entire image processing apparatus 104. The RAM 201 is a readable and writable storage unit that stores programs executed by the CPU 200, and is used as a work area when various processes are performed. The ROM 202 is a non-volatile storage unit storing programs (firmware) executed by the CPU 200. The HDD 203 is a high-capacity storage unit storing various data and programs executed by the CPU 200.

Furthermore, the image processing apparatus 104 includes an LCD (Liquid Crystal Display) 204, a touch panel 205, a print engine 206, a scanner 207, and a fax 208. The image processing apparatus 104 can directly receive input from the user by the LCD 204 and the touch panel 205, and provide various functions. The touch panel 205 is integrally arranged with the LCD 204 that is a display unit, and includes a touch sensor that is a detecting unit for detecting a touch operation from the user. The touch panel 205 displays a menu based on screen data, or receives touch operation from the user. The image processing apparatus 104 may include hard keys, other than the touch panel 205. The print engine 206 is an output unit relevant to image processing by the image processing apparatus 104, and prints images on a sheet and outputs the sheet. The scanner 207 is an input unit relevant to image processing, and optically reads an original document and converts the image into electronic data. Furthermore, the fax 208 is an input output unit relevant to image processing by the image processing apparatus 104, and sends and receives images via a public phone line and the Internet.

Furthermore, the image processing apparatus 104 includes a power source control circuit 209 and a network/subsystem 210. The power source control circuit 209 is a circuit unit for managing the power source control of the image processing apparatus 104. The image processing apparatus 104 includes at least two operation modes; an energy saving mode (second operation mode) in a state where power consumption is reduced because the user is not using the image processing apparatus 104, and a regular mode (first operation mode) in which power is consumed in a regular manner because the user is using the image processing apparatus 104. The power source control circuit 209 transitions the state between the regular mode and the energy saving mode according to the usage state, etc., by the user. Accordingly, it is possible to save power.

The network/subsystem 210 is a circuit unit including NIC (Network Interface Card), and plays the role of relaying between the image processing apparatus 104 and other devices in the network 100. Furthermore, the network/subsystem 210 receives frames and packets that are sent via the network 100.

Next, a description is given of a hardware configuration of the information processing apparatus 101. The information processing apparatus 101 illustrated in FIG. 2 includes a CPU 211, a RAM 212, a ROM 213, an HDD 214, a power source control circuit 215, and a network/subsystem 216. The CPU 211 is a central processing unit for managing and controlling the information processing apparatus 101, and the ROM 213 is a non-volatile storage unit storing programs executed by the CPU 211. The RAM 212 is a readable and writable storage unit that develops programs executed by the CPU 211, and is used as a work area when various processes are performed. The HDD 214 is a high-capacity storage unit storing various data and programs executed by the CPU 211.

The information processing apparatus 101 also has at least two operation modes; the energy saving mode and the regular mode. The power source control circuit 215 controls the operation mode (power consumption state) of the information processing apparatus 101. The network/subsystem 216 is able to communicate with other devices in the network 100.

Next, a description is given of the user PC 110 and the mobile terminal 109. The user PC 110 and the mobile terminal 109 include, for example, a CPU 221, a RAM 222, a ROM 223, a SSD (Solid State Drive) 224, a display 225, a touch panel 226, a keyboard/mouse 227, a network/subsystem 220, etc. In the user PC 110 and the mobile terminal 109, the CPU 221 loads the operating system (OS) and application programs into the RAM 222, and executes these programs. The ROM 223 is a non-volatile storage unit storing programs executed by the CPU 221. The SSD 224 is a high-capacity storage unit storing various data and programs executed by the CPU 221. On the display 225, a user interface is displayed. The touch panel 226 receives touch operations from the user. The user PC 110 and the mobile terminal 109 may include hard keys, other than the touch panel 226. The keyboard/mouse 227 is an input unit for inputting the user's operations. According to these hardware elements, the user PC 110 and the mobile terminal 109 can execute various programs and receive services provided from the image processing apparatus 104.

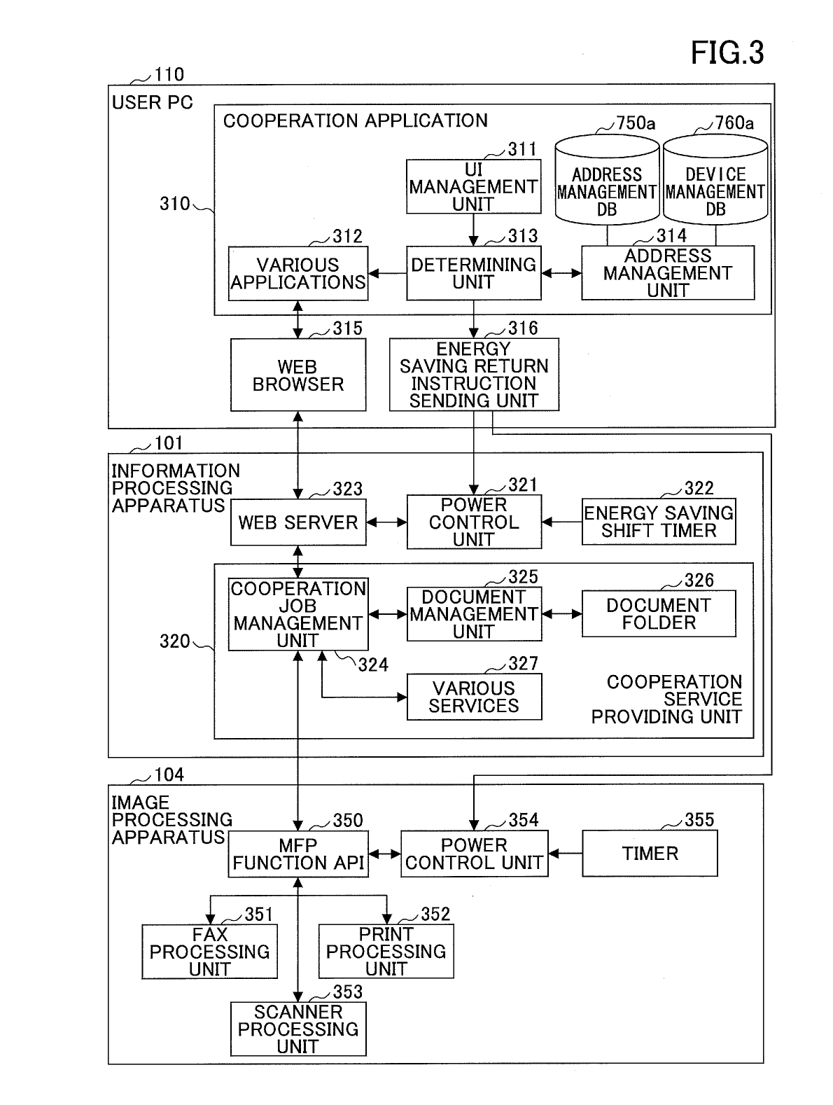

FIG. 3 is an example of a functional block diagram of the devices constituting the information processing system 10 according to the present embodiment. FIG. 3 illustrates an example where a service request is sent from the user PC 110 to the information processing apparatus 101. However, the image processing apparatus 104 can also directly receive input from the user, and therefore it is to be noted that the image processing apparatus 104 can send a service request to the information processing apparatus 101.

The image processing apparatus 104 includes an MFP function API 350, a fax processing unit 351, a print processing unit 352, and a scanner processing unit 353. Note that the functions of these units can be implemented as the CPU 200 of the image processing apparatus 104 executes various programs and controls the respective units. The fax processing unit 351 manages a fax function, and processes jobs relevant to the fax function. The print processing unit 352 manages a print function, and processes jobs relevant to a print function. Furthermore, the scanner processing unit 353 manages a scanner function, and processes jobs relevant to a scanner function. The MFP function API 350 is an application program interface for receiving instructions from an external device (the information processing apparatus 101 in FIG. 3) having a different protocol, and is provided for the external device to use a function of the image processing apparatus 104.

Furthermore, the image processing apparatus 104 includes a power control unit 354 and a timer 355 for managing the time of returning to the energy saving mode. The power control unit 354 transitions the state to the energy saving mode, when a state in which the image processing apparatus 104 is not processing jobs is continued. Furthermore, the power control unit 354 transitions the state to the regular mode from the energy saving mode, when a service request for a job is received or when an instruction to return to the regular mode from the energy saving mode is received. In the energy saving mode also, the power control unit 354 is operating, and can receive energy saving return instruction packets (an instruction to return to the regular mode from the energy saving mode is referred to as an energy saving return instruction, and an energy saving return instruction being sent as an IP packet is referred to as an energy saving return instruction packet).

The timer 355 counts the time during which no jobs are requested from the information processing apparatus 101 functioning as an external controller, and sends a report to the power control unit 354 when a certain amount of time passes. The power control unit 354 that has received the report causes the image processing apparatus 104 to shift to the energy saving mode.

Next, a description is given of the information processing apparatus 101. The information processing apparatus 101 includes a power control unit 321, an energy saving shift timer 322, a Web server 323, a cooperation job management unit 324, a document management unit 325, a document folder 326, and various services 327. The power control unit 321 transitions the state to the energy saving mode, when a state in which the information processing apparatus 101 is not processing jobs is continued. Meanwhile, the power control unit 321 transitions the state to the regular mode from the energy saving mode, when a service request for a job is received or when an instruction to return to the regular mode from the energy saving mode is received.

In the energy saving mode also, the power control unit 321 is operating, and can receive energy saving return instruction packets, and can process the packets. The energy saving shift timer 322 counts the time during which no jobs are requested from the user PC 110 functioning as an external controller. When a certain amount of time passes in the state where no jobs are requested, the energy saving shift timer 322 issues a report to the power control unit 321. The power control unit 321 that has received the report causes the information processing apparatus 101 to shift to the energy saving mode.

The Web server 323 can be implemented as a server program such as Apache (registered trademark), and analyzes the execution instructions received from the user PC 110 by using the HTTP protocol.

After the analysis, the information processing apparatus 101 transfers the job to the cooperation job management unit 324. The cooperation job management unit 324 sends, to the document management unit 325, an execution instruction relevant to the storage/taking over of a document according to the type of the job, and also sends an execution instruction for executing a service such as image processing, etc., to various services 327. The document management unit 325 manages the document folder 326 that is the storage destination of a document.

Various services 327 provide additional functions with respect to the functions of the image processing apparatus 104. Note that in the following, the cooperation job management unit 324, the document management unit 325, the document folder 326, and various services 327 are collectively referred to as a cooperation service providing unit 320.

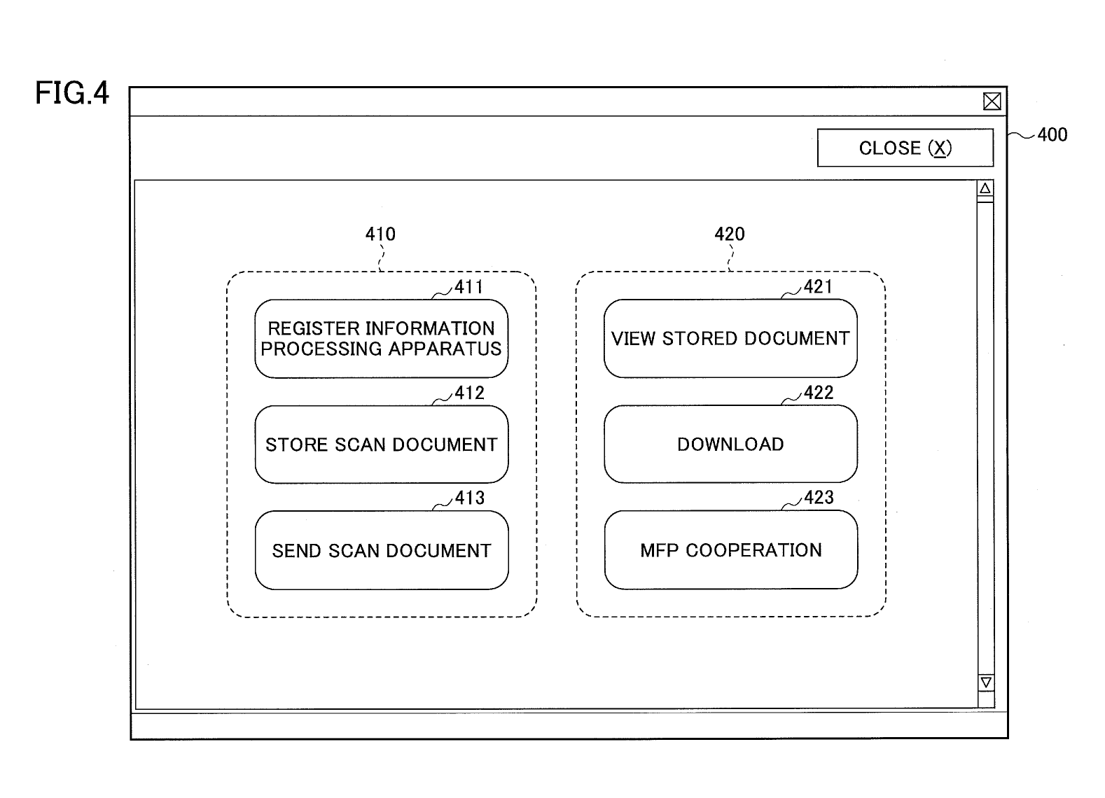

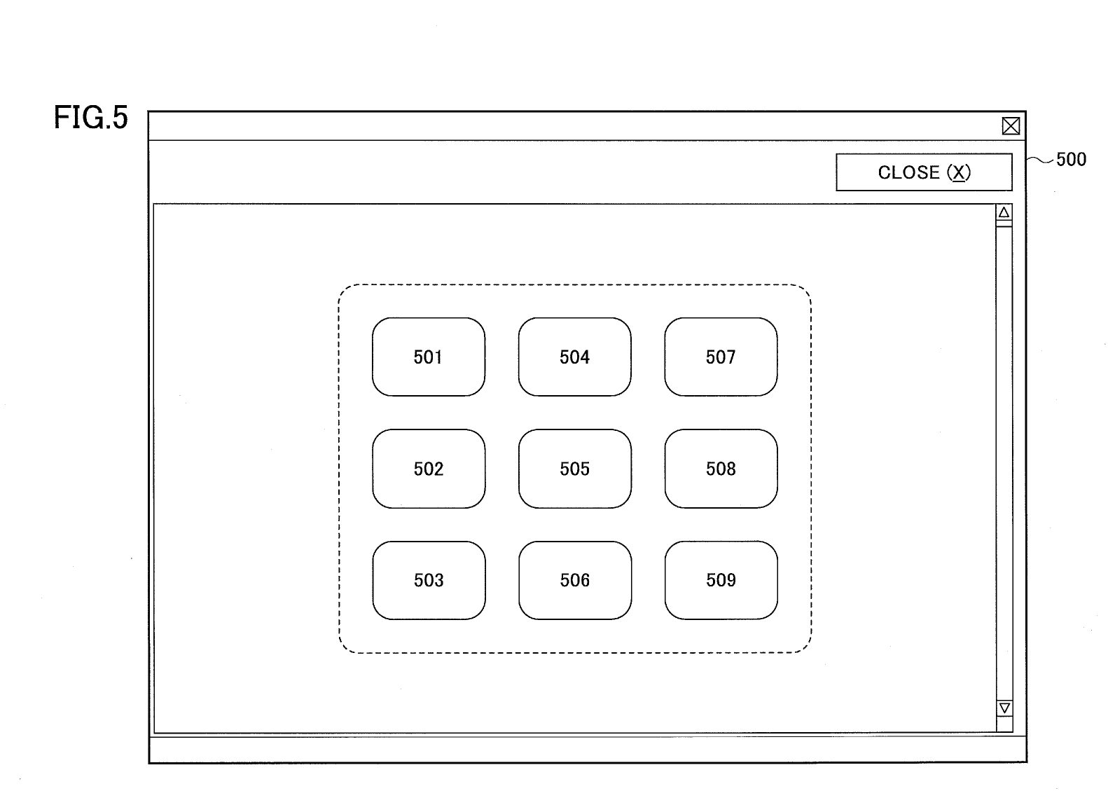

Next, a description is given of the user PC 110. The user PC 110 includes a UI management unit 311, various applications 312, a determining unit 313, an address management unit 314, a web browser 315, and an energy saving return instruction sending unit 316. The UI management unit 311 provides a user interface of a cooperation application 310 implemented in the information processing apparatus 101. Specifically, when the user gives an instruction to press the operation button or to input a mouse event or a key in the cooperation application displayed on the display 225 of the user PC 110, the UI management unit 311 receives the input of the instruction from the user, and performs an operation according to the instruction. Examples of operation screens displayed on the display 225 are illustrated in FIGS. 4 and 5. Details of these screens are given below.

The determining unit 313 determines whether the service request requires a high-speed response, with respect to a service to which the pressed operation button belongs. A service request that requires a high-speed response is described with reference to FIG. 4. When the determining unit 313 determines that the service request requires a high-speed response, the energy saving return instruction sending unit 316 immediately sends an energy saving return instruction to the information processing apparatus 101 and the image processing apparatus 104.

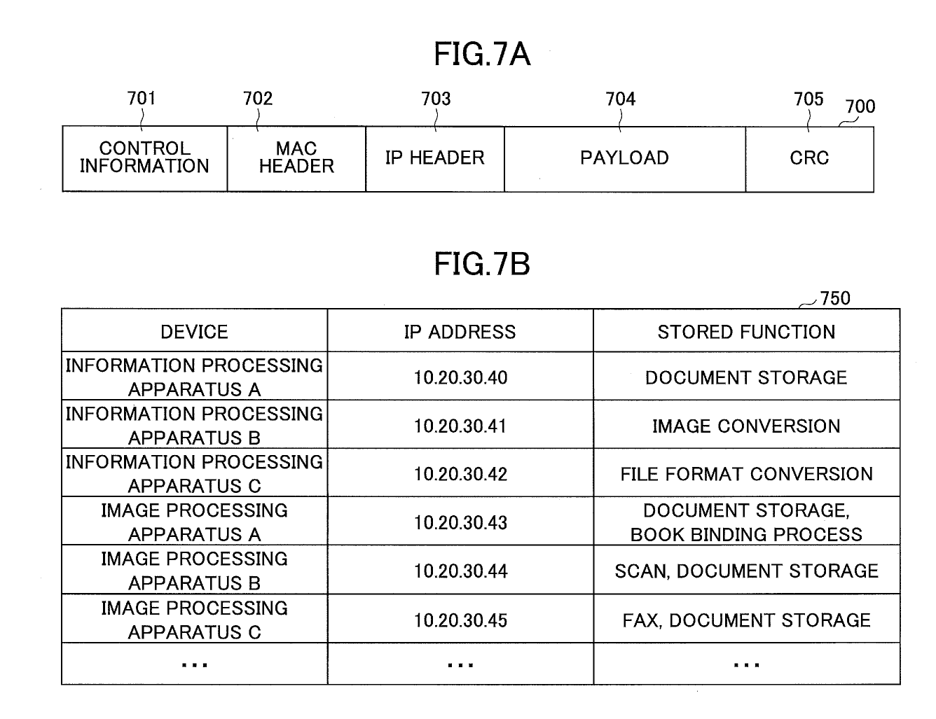

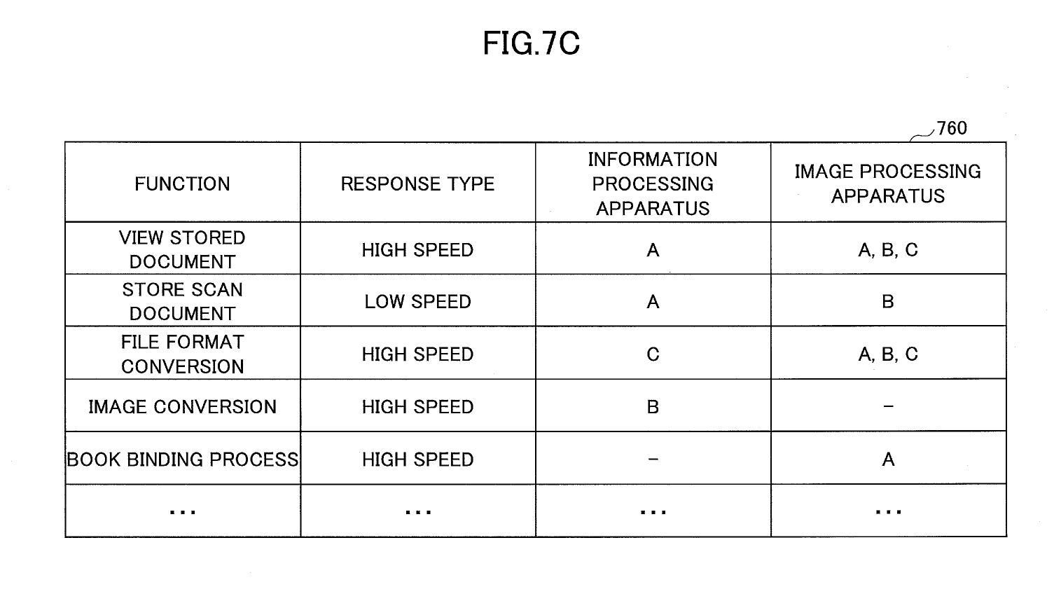

The address management unit 314 manages the identification values and the IP addresses of the information processing apparatus 101 and the image processing apparatuses 104a, 104b, 104c, and 104d. An example of contents managed by the address management unit 314 is illustrated in FIGS. 7A through 7C together with an embodiment of the energy saving return instruction; however, details are given below.

Furthermore, the address management unit 314 includes an address management DB 750a and a device management DB 760a. The address management DB 750a stores an address management table 750 of FIG. 7B, and the device management DB 760a stores a device management table 760 of FIG. 7C. The determination by the determining unit 313 is performed based on the address management table 750 and the device management table 760 illustrated in FIGS. 7B and 7C.

The energy saving return instruction sending unit 316 sends an energy saving return instruction to the IP address of at least one of the information processing apparatus 101 and the image processing apparatus 104 that is a return target, through the network 100 according to the determination result by the determining unit 313, separately from the service request. Furthermore, there may be cases where the energy saving return instruction sending unit 316 issues an instruction to shift to the energy saving mode. Various applications 312 are applications for providing additional functions to the image processing apparatus 104.

Note that the UI management unit 311, various applications 312, the determining unit 313, and the address management unit 314 are collectively referred to as the cooperation application 310.

The web browser 315 sends the service request of the execution job created by the cooperation application 310, according to an HTTP protocol, to the information processing apparatus 101.

### <<User Interface>>

FIG. 4 illustrates an example of a graphical user interface (GUI) 400 displayed on the display 225 of the user PC 110. In the GUI 400, a job list including a plurality of jobs that can be selected by the user, is displayed. Each of the buttons for selecting one of the jobs is referred to as a first operation button.

In the example of FIG. 4, an area 410 displaying a group of jobs that do not require a high-speed response, and an area 420 displaying a group of jobs that require a high-speed response, are displayed.

For example, a group of jobs that do not require a high-speed response includes register information processing apparatus 411, store scan document 412, and send scan document 413. Furthermore, a group of jobs that require a high-speed response includes view stored document 421, download 422, and MFP cooperation 423. MFP cooperation 423 means a software function providing an MFP cooperation function. Note that these are merely examples; there may be jobs that do not require a high-speed response and jobs that require a high-speed response, other than those in FIG. 4.

A description is given of jobs that require a high-speed response and jobs that do not require a high-speed response. In the present embodiment, one mode of a job that requires a high-speed response is a job that the user expects a high-speed response.

(i) A job that the user assumes that the time for the image processing apparatus 104 to finish providing a function, is shorter than the set up time for returning to the regular mode from the energy saving mode.
(ii) A job that can be provided without requiring the operation of a mechanical element in the image processing apparatus 104. Examples of such a process are view stored document 421, download 422, and MFP cooperation 423.
(iii) A process that corresponds to receiving a service from an application server by the user PC 110 via the network 100, when the information processing apparatus 101 is regarded as an application server. Examples of such a service request are searching for an address, searching for an image processing apparatus, and searching various other databases.

Furthermore, in the present embodiment, the following are jobs that do not require a high-speed response.

(i) A job in which the output function by the image processing apparatus 104 is completed on condition that the image processing apparatus 104 returns to the regular mode from the energy saving mode.
(ii) A job that is assumed to be performed in the regular mode, such as making various settings in the image processing apparatus 104. Example of such jobs are register information processing apparatus 411, scanning, send scan document 413, and printing, which require the operations of various engines, and the set up time can be predicted by the user under regular circumstances.

These job groups can be included in, for example, the printer driver of the user PC 110 according to the present embodiment. Furthermore, in another embodiment, the job groups can be created as a data file of the printer driver (for example, a data file having a look-up data table format) which is constituted separately from the cooperation application 310. Accordingly, it is possible to flexibly respond to changes of the functions.

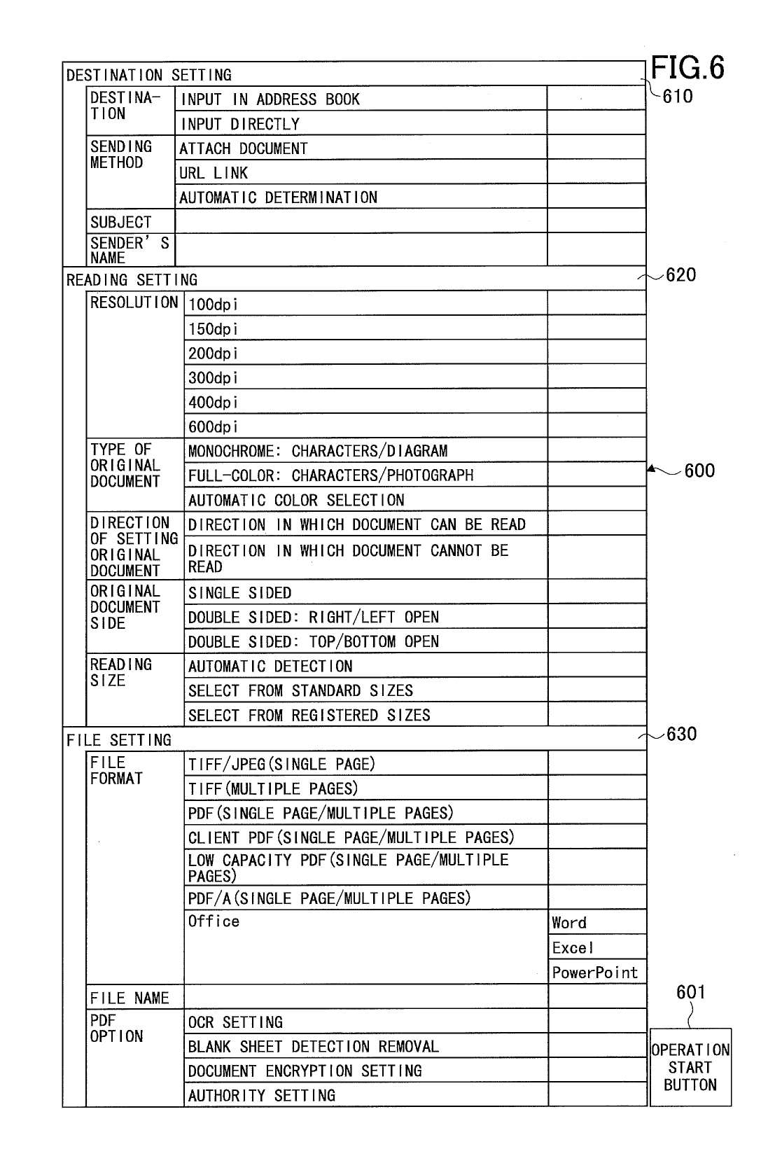

When the user selects, for example, MFP cooperation 423 in the GUI 400, and generates a mouse event, the UI management unit 311 displays a sub GUI 500 by which various settings can be made as illustrated in FIG. 5. The user selects a setting item displayed in the buttons 501 through 509, and generates a mouse event such as a click. The buttons 501 through 509 of FIG. 5 are referred to as second operation buttons. Accordingly, a screen according to the buttons 501 through 509 is displayed (for example, input screen information 600 in FIG. 6).

FIG. 6 illustrates an example of input screen information 600 displayed on the display 225. The input screen information 600 is displayed as the user selects a “corporation function setting” button, which is one of the buttons 501 through 509 in FIG. 5. As settings of corporation functions, the user can make various settings such as destination setting 610, reading setting 620, file setting 630, etc. The displayed input screen information 600 in FIG. 6 may be constituted as, for example, a form, and the user selects a value that the user wants to set from the input screen information 600, and presses an operation start button 601. Accordingly, a service request is sent to the information processing apparatus 101. The information processing apparatus 101 registers various settings by using an appropriate server program such as the Web server 323.

### <<Energy Saving Return Instruction, Energy Saving Return Instruction Packet>>

FIG. 7A illustrates an example of an energy saving return instruction packet 700 that is sent from the user PC 110 to the information processing apparatus 101 and the image processing apparatus 104. The energy saving return instruction sending unit 316 of the user PC 110 issues an energy saving return instruction as an energy saving return instruction packet 700 before issuing a service request, when the user selects a job classified as a high-speed request.

The energy saving return instruction packet 700 includes control information 701, a MAC header 702, and an IP header 703. The control information 701 is a field in which packet information such as the packet length is described. Specifically, the version information, the header length, the service type, etc., are described. Note that the energy saving return instruction may be in a frame format according to the type of the network 100, and when the energy saving return instruction is issued in a frame format, frame synchronization information is described in the control information 701.

The MAC header 702 is a field in which the MAC address of the user PC 110 that is the transmission source, and the MAC address of the information processing apparatus 101 to be the destination are described. Not all of the information processing apparatuses 101a, 101b, and 101c and the image processing apparatuses 104a, 104b, 104c, and 104d can provide the same function, and it is assumed that there may be cases where the functions that can be provided differ according to the information processing apparatuses 101a, 101b, and 101c and the image processing apparatuses 104a, 104b, 104c, and 104d. Therefore, one or more of the information processing apparatuses 101a, 101b, and 101c and the image processing apparatuses 104a, 104b, 104c, and 104d are set as the destinations, and the energy saving return instruction packet 700 is sent to the destinations.

The IP header 703 is an area for describing transport layer information of the OSI basic reference model third layer for sending the energy saving return instruction packet 700. In the IP header 703, the destination IP address, the transmission source IP address, and various kinds of information for assuring the packet quality, are described.

In the payload 704, a command and data corresponding to the energy saving return instruction are described. Examples of the command and data are a command for activating an application for providing a function implemented in the information processing apparatus 101 for a function request; however, the present embodiment is not so limited. In an embodiment in which the energy saving return instruction is applied only in the network 100, the transmission data can be created in a frame format, and in this case, at the end of the transmission frame, CRC (Cyclic Redundancy Check) information 705 is added.

### <<Table Information>>

FIG. 7B illustrates an example of an address management table 750 managed by the user PC 110 according to the present embodiment. In the address management table 750, an IP address and the stored function are registered in association with each device. A description is given of an example of a method of creating the address management table 750.

First, an IP address is assigned by a DHCP server, and it is assumed that the IP address is not necessarily fixed. In this case, the address management unit 314 of the user PC 110 searches for the information processing apparatuses 101a, 101b, and 101c and the image processing apparatuses 104a, 104b, 104c, and 104d from the network 100. For example, the network address of the user PC 110 is obtained, and the information processing apparatuses 101a, 101b, and 101c and the image processing apparatuses 104a, 104b, 104c, and 104d are searched from the same network address. It can be determined whether the device is compatible with the cooperation application 310 by referring to a MIB (Management Information Base) described below.

When the IP address is fixed (assigned by or not assigned by the DHCP server), the user PC 110 holds the IP addresses of the information processing apparatuses 101a, 101b, and 101c and the image processing apparatuses 104a, 104b, 104c, and 104d.

For example, the user PC 110 has a function of a host of SNMP (Small Network Management Protocol), and the information processing apparatus 101 and the image processing apparatus 104 have a function as an agent of a management target.

When the process according to the present embodiment is performed with respect to the user PC 110, the address management unit 314 of the user PC 110 issues a get_request to each of the agents when installing a printer driver (for example, by broadcasting or multicasting), and acquires a get_response from each of the agents. Then, the user

PC 110 acquires what kind of function is stored by each of the information processing apparatuses 101a, 101b, and 101c and the image processing apparatuses 104a, 104b, 104c, and 104d that are agents, by causing these devices to send MIB information, for example.

Then, when the address management unit 314 receives a get_response packet, the address management unit 314 registers, in the address management table 750, the IP address and the function in association with each of the information processing apparatuses 101 and the image processing apparatuses 104. Note that when the MAC address of the information processing apparatus 101 and the image processing apparatus 104 is necessary, the MAC address is acquired by issuing an ARP (Address Resolution Protocol) request to the acquired IP address, and the MAC address is added to the address management table 750.

Note that the information processing apparatuses A through C in FIGS. 7B and 7C are identification values (names, etc.) of the information processing apparatuses 101a, 101b, and 101c. The image processing apparatuses A through C are identification values (names, etc.) of the image processing apparatuses 104a, 104b, and 104c.

FIG. 7C illustrates an example of a device management table 760. The device management table 760 includes a list of functions, the “response type” corresponding to each “function”, the “information processing apparatus”, and the “image processing apparatus”, registered in association with each other. As the “response type”, the speed of the response is set as “high speed” or “low speed”. For a function that is provided by a job that requires a high-speed response, “high speed” is set, and for a function that is provided by a job that does not require a high-speed response, “low speed” is set.

The device management table 760 is also collected from each device by the user PC 110 via the network 100 and stored in advance. That is, the “response type” is also provided by, for example, MIB. Alternatively, the device management table 760 may be downloaded via a network. Alternatively, the device management table 760 may be set by the developer of the cooperation application 310.

Note that the address management table 750 and the device management table 760 may be information data used by the printer driver. The address management table 750 and the device management table 760 may be stored in the ROM 223 or the SSD 224 in which information can be written and read any time. In this case, the CPU 221 of the user PC 110 can use these tables as look-up tables that can be accessed according to need.

The energy saving return control is performed based on the information stored in the address management table 750 and the device management table 760. The UI management unit 311 of the user PC 110 refers to the device management table 760 and causes the GUI 400 illustrated in FIG. 4 to be displayed. The user does not need to recognize which function is set as a high-speed response and which function is not set as a high-speed response; however, “high speed” or “low speed” may be displayed at each job in the GUI 400. As these items are displayed, the user can recognize whether the function is set as a high-speed response or not. When a job that requires a high-speed response is selected, the user can act upon predicting that the waiting time will be short.

### Operation Procedures

### First Embodiment

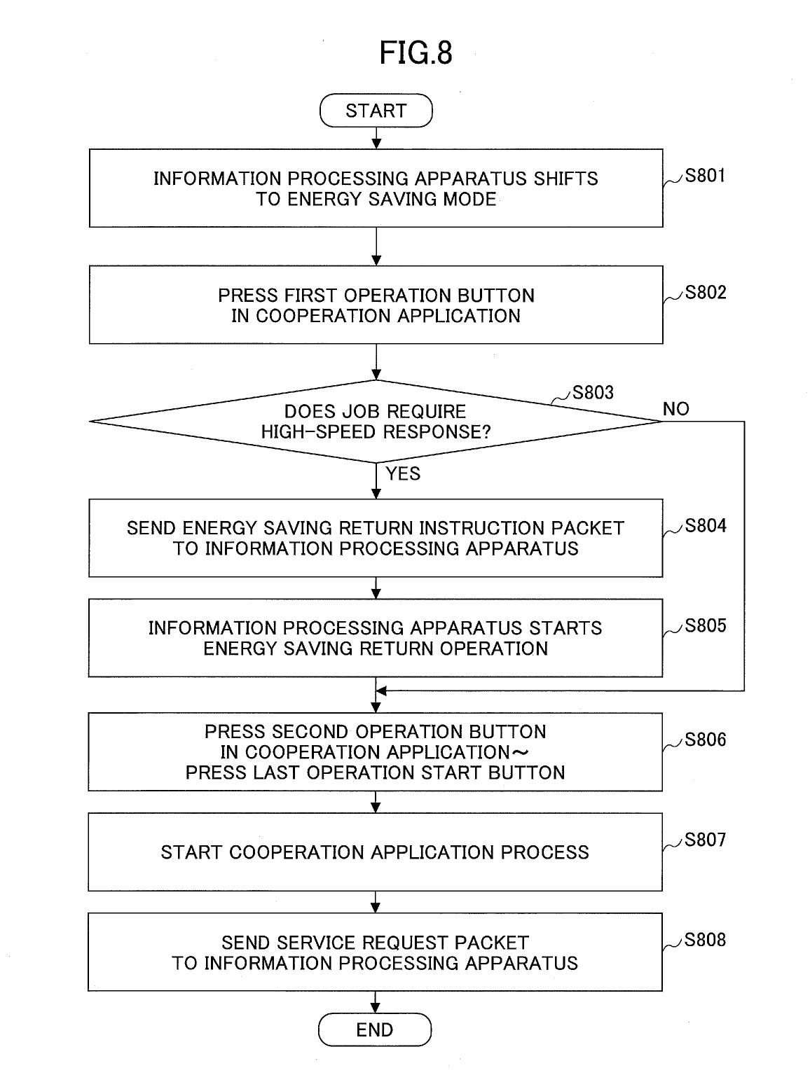

FIG. 8 is a flowchart of a process according to a first embodiment executed by the information processing system 10 according to the present embodiment. The process of FIG. 8 starts when the information processing apparatus 101 is in a regular mode.

First, in step S801, the information processing apparatus 101 shifts to an energy saving mode. In step S802, the cooperation application 310 is activated at the user PC 110, and the UI management unit 311 displays jobs that can be selected, on the GUI 400 illustrated in FIG. 4. The user operates a first operation button, and the UI management unit 311 receives the job selected by the user.

In step S803, the determining unit 313 of the user PC 110 refers to the device management table 760, and determines whether the function provided by the job selected by the user is a job that requires a high-speed response. Note that the determining unit 313 refers to the address management table 750, and determines at least one of the information processing apparatuses 101a, 101b, and 101c that can provide the function of the job selected by the user.

When the job requires a high-speed response (YES in step S803), in step S804, the energy saving return instruction sending unit 316 sends an energy saving return instruction packet separately from the service request, to the information processing apparatus 101 determined in step S803.

In step S805, the information processing apparatus 101 receives the energy saving return instruction packet, and the power control unit 321 starts an energy saving return operation. This process may include, for example, a process of making the power supply to the CPU 211 return to a regular mode and activating the HDD 214; however, the process is not so limited.

Meanwhile, when the determination of step S803 is NO, the process branches to step S806, and a cooperation process is started.

In step S806, the UI management unit 311 displays the sub GUI 500 at the user PC 110, and the user presses the second operation button and inputs various settings. Next, the input screen information 600 of FIG. 6 is displayed, and lastly, the operation start button 601 is pressed.

In step S807, various applications 312 of the user PC 110 start the process of the cooperation application 310, and in step S808, the web browser 315 sends a service request packet to the information processing apparatus 101.

The processes of steps S803, S805, S807, and S808 are performed without being known by the user, and therefore the user can receive a service according to device cooperation by the information processing apparatus 101 and the image processing apparatus 104, without noticing that the information processing apparatus 101 returns from the energy saving mode. Furthermore, when a job that requires a high-speed response is selected, an energy saving return instruction is sent, and therefore the user can receive a service with a short time delay.

### First Modification Example

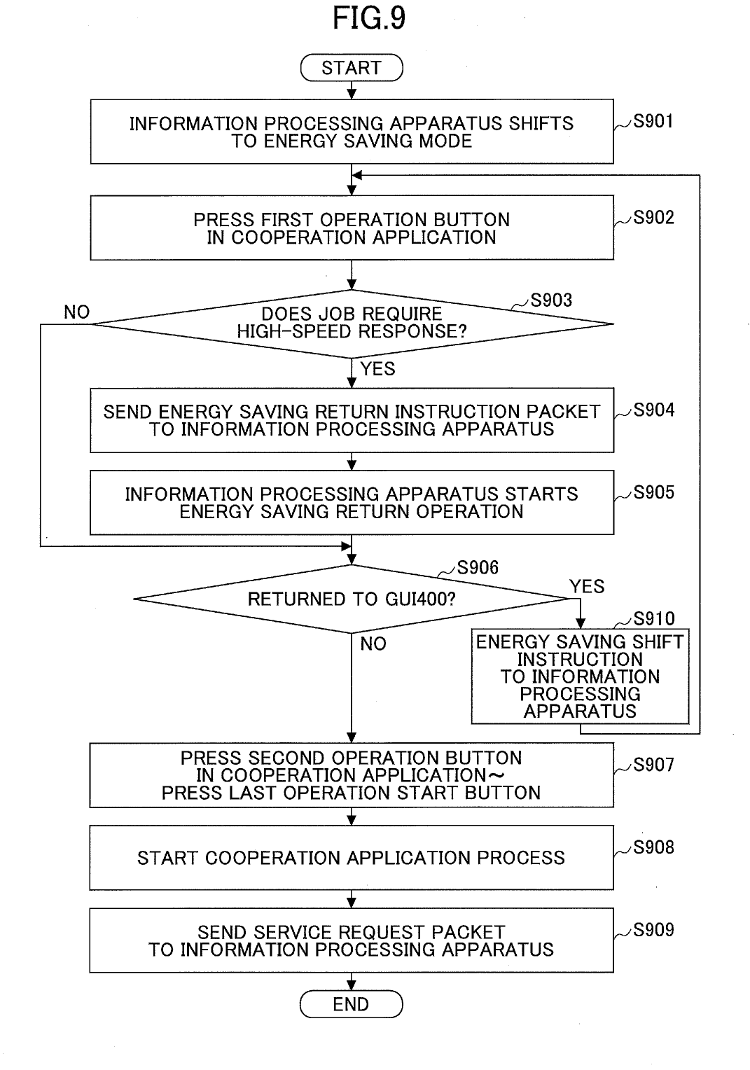

FIG. 9 is a flowchart of a first modification example of the process according to the first embodiment. The first modification example is an embodiment to address a case where the user changes the requested service, and is different from the process of FIG. 8 in that steps S906 and S910 are added. In the following, a detailed description is given of the processes that are different from those of FIG. 8.

In step S905, after the energy saving return instruction packet is received from the user PC 110, the information processing apparatus 101 starts an energy saving return operation.

In step S906, the UI management unit 311 of the user PC 110 monitors the operation of the user, and determines, for example, whether a “return” button is pressed, or a mouse event corresponding to a “return” button is generated, by the user. Accordingly, the GUI 400 is displayed on the display 225.

When it is determined that a “return” request is generated in step S906 (YES in step S906), in step S910, the energy saving return instruction sending unit 316 issues an instruction to forcibly return to the energy saving mode, to the information processing apparatus 101. Subsequently, the process returns to step S902.

Furthermore, when it is determined that an event other than the “return” request is generated in step S906 (NO in step S906), the process proceeds to step S908, and the process is executed in the same manner as FIG. 8.

According to the operation procedures illustrated in FIG. 9, even when the user erroneously specifies a job, the information processing apparatus 101 can quickly shift to the energy saving mode, and therefore it is possible to prevent energy from being wastefully consumed.

### Second Modification Example

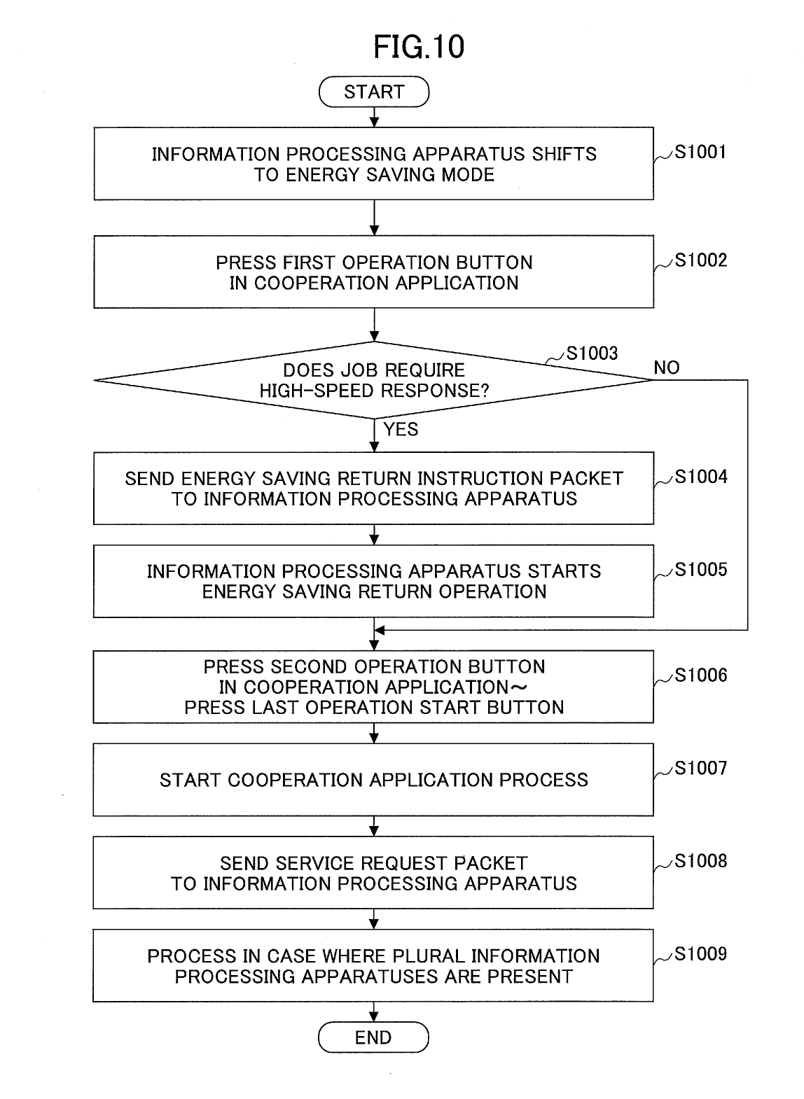

FIG. 10 is a flowchart of a second modification example of the process according to the first embodiment. FIG. 10 is a flowchart of a preferred embodiment that is applicable when the information processing system 10 cannot identify the functions of the information processing apparatuses 101a, 101b, and 101c.

A plurality of information processing apparatuses 101a, 101b, and 101c are connected in the information processing system 10; however, there may be cases where it is not possible to acquire the information of the information processing apparatuses 101a, 101b, and 101c in advance, because the SNMP protocol is not accommodated as described above, etc. Furthermore, there may be cases where the information processing apparatuses 101a, 101b, and 101c do not have fixed IP addresses, and the IP addresses cannot be identified (because the IP address cannot be identified, the address management unit 314 cannot acquire the function of the information processing apparatus 101). Furthermore, when the user PC 110 performs communication by using a protocol other than TCP/IP, for example, frame relay, the IP address of the information processing apparatus 101 cannot be identified. Accordingly, in the present modification example, the user PC 110 sends energy saving return instruction packets to a plurality of information processing apparatuses 101a, 101b, and 101c.

In the process illustrated in FIG. 10, steps S1001 through S1008 are the same as FIG. 8. However, FIG. 10 is different from FIG. 8 in that in steps S1004 and S1008, the energy saving return instruction sending unit 316 and the web browser 315 respectively send the energy saving return instruction packet and the service request packet to the network 100, by broadcast communication (IPv4 protocol) or multicast communication (IPv6 protocol).

Therefore, when an energy saving return instruction packet is sent in step S1004, the information processing apparatuses 101a, 101b, and 101c according to the present embodiment start a process of returning from the energy saving mode.

If the process is continued in this state, even an information processing apparatus 101 that does not execute a job is maintained in a regular mode until the energy saving shift timer 322 expires, which is not preferable. Therefore, among the information processing apparatuses 101a, 101b, and 101c, devices other than the device responding to the service request shift to the energy saving mode.

Thus, in the procedures of FIG. 10, after the user PC 110 sends a service request packet in step S1008, in step S1009, a process is executed for a case where there are a plurality of information processing apparatuses 101a, 101b, and 101c. The process of step S1009 may be executed by the user PC 110, or may be executed by the information processing apparatus 101. Specifically, the following process can be performed.

In the described embodiment, at the user PC 110, a command for directly executing a requested service is described, together with a path specification, in a service request packet to be sent in step S1008 by the web browser 315. Then, when the cooperation job management unit 324 finds an execution file name that the own device can process in the service request packet, the corresponding information processing apparatus 101 issues a report including the IP address of the own device, to the user PC 110. For example, it is assumed that the information processing apparatus 101a has issued a report including the IP address of the own device, to the user PC 110.

After receiving the report, the user PC 110 instructs the information processing apparatuses 101b, 101c and the image processing apparatuses 104, which are the devices other than the issue source of the report, to shift to energy saving. Thus, the information processing apparatuses 101b, 101c and the image processing apparatuses 104 that have temporarily returned to the regular mode, can transit to the energy saving mode before the energy saving shift timer 322 elapses, and therefore excessive energy consumption can be avoided.

Note that when the cooperation job management unit 324 cannot find an execution file name that the own device can process in the service request packet, the corresponding information processing apparatus 101 may issue a report including the IP address of the own device to the user PC 110.

In another embodiment, when the cooperation job management unit 324 of the information processing apparatuses 101a, 101b, and 101c cannot find a command that the own device can process in the service request packet, the information processing apparatuses 101a, 101b, and 101c immediately start an energy saving retreating process. According to this embodiment, it is possible to omit the transactions with the user PC 110, and therefore the information processing apparatuses 101a, 101b, and 101c can quickly retreat to the energy saving mode.

### Second Embodiment

In a second embodiment, a description is given of an embodiment in which the user PC 110 sends a return request instruction packet also to the image processing apparatus 104.

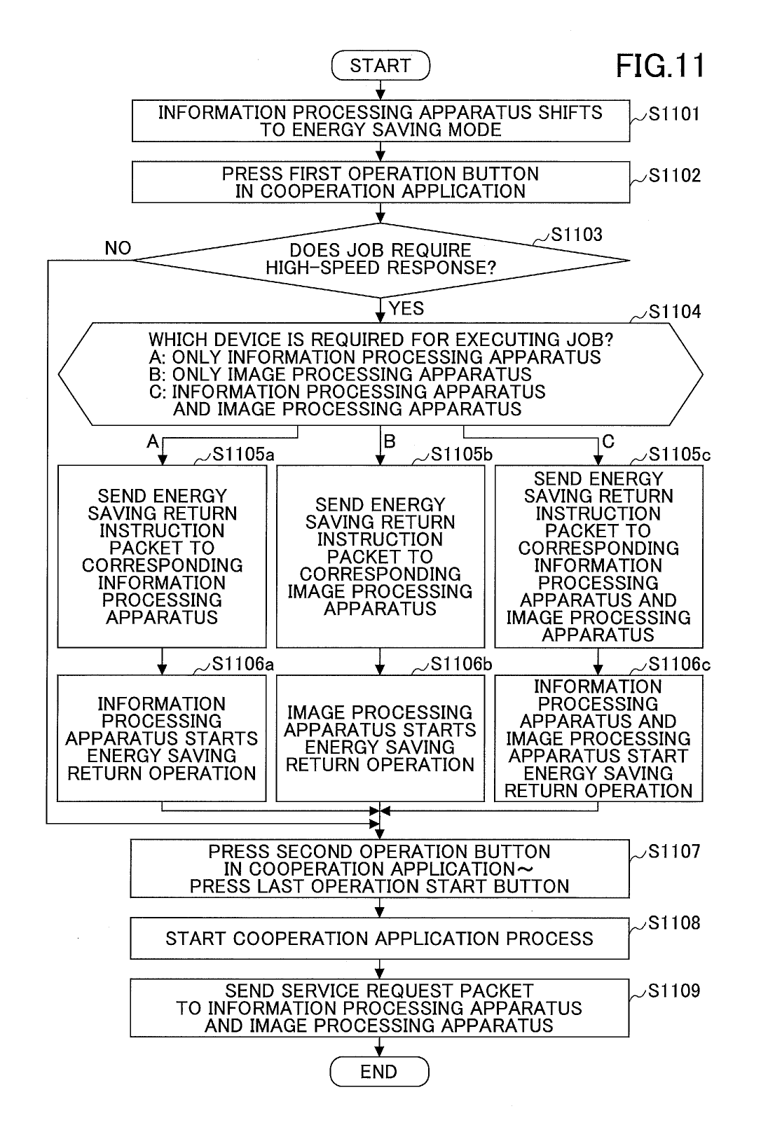

FIG. 11 is a flowchart of a process according to a second embodiment executed by the information processing system 10 according to the present embodiment. The process of FIG. 11 starts when the information processing apparatus 101 is in a regular mode.

First, in step S1101, the information processing apparatus 101c shifts to an energy saving mode.

In step S1102, the cooperation application 310 is activated at the user PC 110, and the UI management unit 311 displays jobs that can be selected, on the GUI 400 illustrated in FIG. 4. The user presses a first operation button, and the UI management unit 311 receives the job selected by the user.

In step S1103, the determining unit 313 of the user PC 110 refers to the device management table 760, and determines whether the function provided by the job selected by the user is a job that requires a high-speed response. Note that the determining unit 313 refers to the address management table 750, and determines which of the information processing apparatuses 101a, 101b, and 101c and the image processing apparatuses 104a, 104b, 104c, and 104d can provide the function of the job selected by the user.

When the job requires a high-speed response (YES in step S1103), in step S1104, the determining unit 313 refers to the device management table 760 and determines the device required for executing the job.

The determining unit 313 refers to the device management table 760, and identifies a function corresponding to a job that requires a high-speed response, and the information processing apparatuses 101a, 101b, and 101c and the image processing apparatuses 104a, 104b, 104c, and 104d holding the function.

When the device required for executing the job is “A: only information processing apparatus”, the process proceeds to step S1105a, and the energy saving return instruction sending unit 316 sends an energy saving return instruction packet to one or more of the corresponding information processing apparatuses 101a, 101b, and 101c obtained from the information of the device management table 760.

Furthermore, when the device required for executing the job is “B: only image processing apparatus”, the process proceeds to step S1105b, and the energy saving return instruction sending unit 316 refers to the device management table 760, and sends an energy saving return instruction packet to one or more of the corresponding image processing apparatuses 104a, 104b, 104c, and 104d.

When the devices required for executing the job are “C: information processing apparatus and image processing apparatus”, the process proceeds to step S1105c, and the energy saving return instruction sending unit 316 sends an energy saving return instruction packet to one or more of the corresponding information processing apparatuses 101a, 101b, and 101c and the image processing apparatuses 104a, 104b, 104c, and 104d.

Specific examples of applying the processes of steps S1105a through S1105c are described below.
When the function is “view stored document”, a high-speed response is set, and therefore a process of sending an energy saving return instruction packet to the information processing apparatus A and the image processing apparatuses A, B, C is executed.
When the function is “store scan document”, a low-speed response is set, and therefore the energy saving return instruction packet according to the present embodiment is not sent.
When the function is “image conversion”, a high-speed response is set, and therefore a process of sending an energy saving return instruction packet to the information processing apparatus B is executed.
When the function is “book binding process”, a high-speed response is set, and therefore a process of sending an energy saving return instruction packet to the image processing apparatus A is executed. Note that the “book binding process” in the present embodiment is a collective term for finishing processes including combine, staple, punch, sort, etc.

Subsequently, in steps S1106a through S1106c, the power control unit 321 of each device that received the energy saving return instruction packet starts an energy saving return operation. By these processes, the user PC 110 can select the device that requires high-speed processing and send an energy saving return instruction packet.

Meanwhile, when it is determined that the job does not require a high-speed response in step S1103 (NO in step S1103), the process branches to step S1107.

In step S1107, the UI management unit 311 displays the sub GUI 500 on the display 225 at the user PC 110, and the user presses the second operation button and inputs various settings. Next, the input screen information 600 of FIG. 6 is displayed, and lastly, the operation start button 601 is pressed.

In step S1108, various applications 312 of the user PC 110 start the process of the cooperation application 310, and in step S1109, the web browser 315 sends a service request packet to one or more of the information processing apparatuses 101 and the image processing apparatuses 104 selected in step S1104.

Therefore, similar to the first embodiment, the user can receive a service according to device cooperation by the information processing apparatus 101 and the image processing apparatus 104, with a short time delay.

### First Modification Example

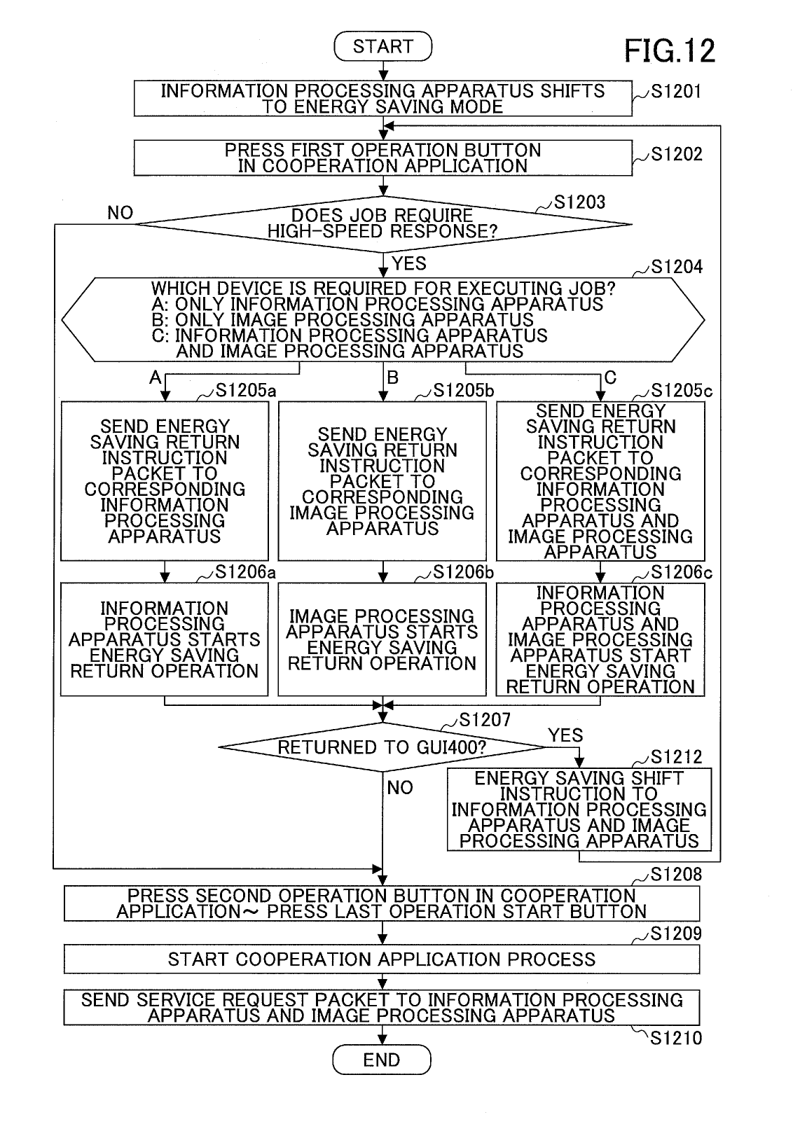

FIG. 12 is a flowchart of a first modification example of the process according to the second embodiment. The first modification example is an embodiment to address a case where the user changes the requested service, and is different from the process of FIG. 11 in that steps S1207 and S1212 are added. In the following, a detailed description is given of the processes that are different from those of FIG. 11.

In step S1205, after the energy saving return instruction packet is received from the user PC 110, the information processing apparatus 101 and the image processing apparatus 104 start an energy saving return operation.

In step S1207, the UI management unit 311 of the user PC 110 monitors the operation of the user, and determines, for example, whether a “return” button is pressed, or a mouse event corresponding to a “return” button is generated, by the user. Accordingly, the GUI 400 is displayed on the display 225.

When it is determined that a “return” request is generated in step S1207 (YES in step S1207), in step S1212, the energy saving return instruction sending unit 316 issues an instruction to forcibly return to the energy saving mode, to all of the information processing apparatuses 101 and the image processing apparatuses 104. Subsequently, the process returns to step S1202. Note that at this time, an instruction to return to the energy saving mode may only be issued to the information processing apparatus 101 and the image processing apparatus 104 to which the energy saving return instruction packet has been sent.

Furthermore, when it is determined that an event other than the “return” request is generated in step S1207 (NO in step S1207), the process proceeds to step S1209, and the process is executed in the same manner as FIG. 11.

Therefore, even when the user erroneously selects a job, it is possible to prevent the energy from being wastefully consumed.

### Second Modification Example

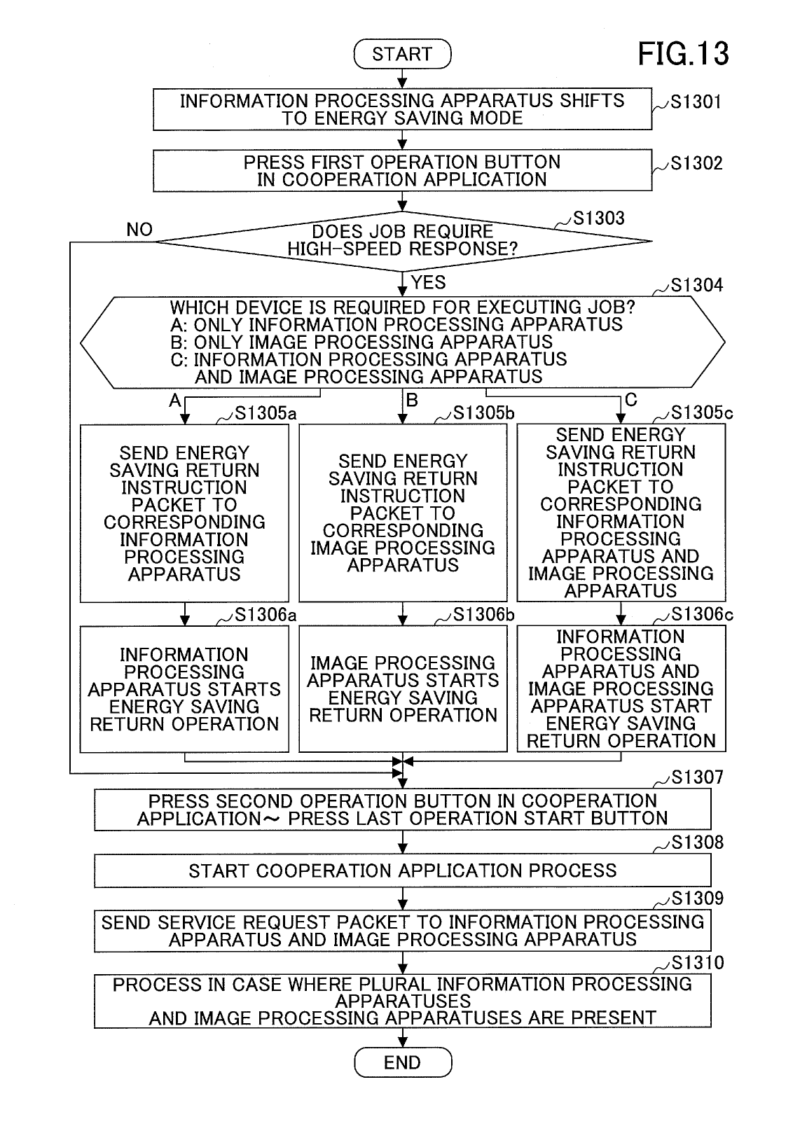

FIG. 13 is a flowchart of a second modification example of the process according to the second embodiment. FIG. 13 is a flowchart of a preferred embodiment that is applicable when the information processing system 10 cannot identify the functions of the information processing apparatuses 101a, 101b, and 101c and the image processing apparatuses 104a, 104b, 104c, and 104d.

In the process illustrated in FIG. 13, steps S1301 through S1308 are the same as FIG. 11. However, FIG. 13 is different from FIG. 11 in that in steps S1304 and S1308, the web browser 315 and the energy saving return instruction sending unit 316 respectively send the energy saving return instruction packet and the service request packet to the network, by broadcast communication (IPv4 protocol) or multicast communication (IPv6 protocol). Therefore, when an energy saving return instruction packet is sent in step S1304, the information processing apparatuses 101 and the image processing apparatuses 104 respectively start a process of returning from the energy saving mode.

Next, after the user PC 110 sends a service request packet in step S1309, in step S1310, a process is executed for a case where there are a plurality of information processing apparatuses 101 and image processing apparatuses 104. This process is the same as step S1009 of FIG. 10.

### Other Application Examples

In the above embodiment, the cooperation application 310 is implemented in the user PC 110; however, the cooperation application 310 may be implemented in another system present in a smart device or the operation unit of the image processing apparatus 104. Furthermore, HTTP is used as the communication protocol of the network 100; however, in another variation example, communication protocols other than HTTP may be used, such as UDP, HTTPS, etc.

As other variation examples, there are a multi system configuration in which a CPU is installed in the operation unit of the image processing apparatus 104 and this operation unit provides a unique solution, an outdoor wireless infrastructure (3G, LTE, IEEE801.xx, etc.) may be used for connecting a smart device and a network, a Wi-Fi communication standard among the image processing apparatuses 104 or the information processing apparatuses 101 may be used for connecting a smart device and a network, and Wi-Fi ad hoc among the image processing apparatuses 104 or the information processing apparatuses 101 may be used for connecting a smart device and a network.

According to one embodiment of the present invention, an information processing apparatus and an information processing system are provided, which are capable of reducing the waiting time of a user using a function.

The information processing apparatus and the information processing system are not limited to the specific embodiments described herein, and variations and modifications may be made without departing from the spirit and scope of the present invention.

The present application is based on and claims the benefit of priority of Japanese Priority Patent Application No. 2014-233474, filed on Nov. 18, 2014, Japanese Priority Patent Application No. 2015-074986, filed on Apr. 1, 2015, and Japanese Priority Patent Application No. 2015-117982, filed on Jun. 11, 2015, the entire contents of which are hereby incorporated herein by reference.

What is claimed is:

1. An information processing apparatus for requesting information processing via a network, the information processing apparatus comprising:
a request unit configured to send a request for the information processing to at least one image processing apparatus via the network;
a return unit configured to cause a request processing apparatus to return to a first operation mode from a second operation mode, wherein the request processing apparatus supplements a function when the image processing apparatus executes the information processing, and the request processing apparatus operates in the first operation mode and in the second operation mode in which power consumption is lower than that of the first operation mode; and
a determining unit configured to determine whether the information processing requested by the request unit is a predetermined type, wherein
when the determining unit determines that the information processing is the predetermined type, the return unit causes the request processing apparatus to return to the first operation mode from the second operation mode, before the request unit sends the request for the information processing to the request processing apparatus.

2. The information processing apparatus according to claim 1, wherein
the predetermined type of the information processing is stored in advance in a first storage unit based on whether operation of a mechanical element of the image processing apparatus is required for executing the information processing or based on a user's prediction, and
the determining unit refers to the first storage unit and determines whether the information processing is the predetermined type.

3. The information processing apparatus according to claim 2, further comprising:
an information acquiring unit configured to acquire, from the request processing apparatus connected to the network, information indicating whether operation of a mechanical element of the image processing apparatus is required for executing the information processing or whether the information processing requires a first speed determined based on a user's prediction or a second speed that is lower than the first speed, with respect to each information processing, and store the acquired information in the first storage unit, and
the determining unit determines that the information processing is the predetermined type when the first speed is registered in association with the information processing in the first storage unit.

4. The information processing apparatus according to claim 2, wherein
the return unit generates an energy saving return instruction for causing the request processing apparatus to return to the first operation mode from the second operation mode according to a determination result by the determining unit, separately from the request for the information processing, before the request unit sends the request for the information processing.

5. The information processing apparatus according to claim 1, wherein
the image processing apparatus operates in the first operation mode and in the second operation mode, and
when the determining unit determines that the information processing is the predetermined type, the return unit causes the image processing device to return to the first operation mode from the second operation mode, before the request unit sends the request for the information processing to the request processing apparatus.

6. The information processing apparatus according to claim 5, wherein
when a user interface for receiving a selection of the information processing is displayed after the return unit sends a return request to cause the request processing apparatus or the image processing apparatus to return to the first operation mode from the second operation mode,
the return unit causes the request processing apparatus or the image processing apparatus to shift to the second operation mode from the first operation mode.

7. The information processing apparatus according to claim 5, wherein
when the request unit sends the request for the information processing to a plurality of the request processing apparatuses or the image processing apparatuses,
the return unit causes the request processing apparatus or the image processing apparatus that does not execute the information processing to shift to the second operation mode from the first operation mode, based on information indicating whether the information processing can be processed which is acquired from the plurality of request processing apparatuses or the image processing apparatuses.

8. The information processing apparatus according to claim 5, further comprising:
a second information acquiring unit configured to acquire the information processing that can be processed by the request processing apparatus or the image processing apparatus from the request processing apparatus or the image processing apparatus connected to the network, and store the acquired information processing in a second storage unit, wherein
the return unit causes the request processing apparatus or the image processing apparatus, which can process the information processing based on the second storage unit, to return to the first operation mode from the second operation mode, before the request unit sends the request for the information processing to the request processing apparatus.

9. The information processing apparatus according to claim 1, wherein
the information processing apparatus is a personal computer (PC) or an image forming apparatus.

10. The information processing apparatus according to claim 1, wherein
the information processing apparatus is a smart device.

11. The information processing apparatus according to claim 1, wherein
the request processing apparatus is a computer or a multifunction copier.

12. An information processing system comprising:
an image processing apparatus;
a request processing apparatus configured to operate in a first operation mode and in a second operation mode in which power consumption is lower than that of the first operation mode, wherein the request processing apparatus supplements a function when the image processing apparatus executes information processing; and
an information processing apparatus configured to send a request for the information processing to the image processing apparatus via a network, wherein
the information processing apparatus includes
a return unit configured to cause the request processing apparatus to return to the first operation mode from the second operation mode, and
a determining unit configured to determine whether the information processing requested to the image processing apparatus is a predetermined type, wherein
when the determining unit determines that the information processing is the predetermined type, the return unit causes the request processing apparatus to return to the first operation mode from the second operation mode, before sending the request for the information processing to the request processing apparatus.

13. A non-transitory computer-readable recording medium storing a program that causes a computer to execute a process, the computer constituting an information processing apparatus for requesting information processing via a network, the process comprising:
sending a request for the information processing to at least one image processing apparatus via the network;
causing a request processing apparatus to return to a first operation mode from a second operation mode, wherein the request processing apparatus operates in the first operation mode and in the second operation mode in which power consumption is lower than that of the first operation mode; and
determining whether the requested information processing is a predetermined type, wherein
when it is determined that the information processing is the predetermined type, the request processing apparatus is caused to return to the first operation mode from the second operation mode, before the request for the information processing is sent to the request processing apparatus.
